(19) United States
(12) Patent Application Publication
(10) Pub. No.: US 2014/0009472 A1
(43) Pub. Date: Jan. 9, 2014

(54) INFORMATION PROCESSING DEVICE, INFORMATION PROVIDING DEVICE, INFORMATION SYSTEM, AND COMPUTER PROGRAM PRODUCT

(71) Applicant: KABUSHIKI KAISHA TOSHIBA, Tokyo (JP)

(72) Inventors: Daisuke AJITOMI, Tokyo (JP); Keisuke MINAMI, Kanagawa (JP); Shinya MURAI, Kanagawa (JP); Hiroyuki AIZU, Kanagawa (JP)

(73) Assignee: KABUSHIKI KAISHA TOSHIBA, Tokyo (JP)

(21) Appl. No.: 13/933,462

(22) Filed: Jul. 2, 2013

(30) Foreign Application Priority Data
Jul. 3, 2012 (JP) 2012-149369

(51) Int. Cl. G06T 11/20

(52) U.S. Cl. CPC G06T 11/206
USPC 345/440

(57) ABSTRACT

An example information processing device includes a first memory that can store graph data indicating at least either nodes or edges constituting a graph and a second memory that can store graph data at an access speed faster than an access speed of the first memory. An obtaining unit obtains relational data containing relationships that can be converted into at least one graph. A determining unit determines whether to store certain graph data in the first or second memory, based on at least any of specification information specifying a storage destination for the certain graph data, or relations of connection with respect to the graph data stored in the first or second memory, and a data size of the relational data. A memory controller stores the certain graph data in the first or second memory based on the determination.

### CROSS-REFERENCE TO RELATED APPLICATIONS

This application is based upon and claims the benefit of priority from Japanese Patent Application No. 2012-149369, filed on Jul. 3, 2012; the entire contents of which are incorporated herein by reference.

### FIELD

Embodiments described herein relate generally to an information processing device, an information providing device, an information system, and a computer program product.

### BACKGROUND

At present, relational databases that are in line with the relational data model are in widespread use. Moreover, in-memory databases are known as a means to enhance the database speed. In an in-memory database; the architecture is such that data, indexes, and temporary data are all present in a memory on the premise of memory accesses only. As an example of an in-memory database, a graph database is known in which data is stored in the nodes and the edges of a graph.

However, in the case of using a graph database as an in-memory database, it becomes necessary to perform a large number of write operations such as caching to a memory during insertions or merging within a memory. As a result, there are times when it is not possible to achieve a sufficient throughput.

### BRIEF DESCRIPTION OF THE DRAWINGS

FIG. 1 is a functional block diagram illustrating an exemplary configuration of an information processing device according to a first embodiment;

FIGS. 2A to 2C are diagrams illustrating an exemplary storage format of graph data in a first memory unit;

FIG. 3 is a sequence diagram illustrating an example of operations performed by the information processing device according to the first embodiment for the purpose of graph data registration;

FIGS. 4A and 4B are conceptual diagrams illustrating an example of relational data obtained by a first obtaining unit;

FIGS. 5A to 5C are diagrams illustrating an example of the file status after a graph data updating operation is performed in the first memory unit;

FIGS. 6A to 6C are diagrams illustrating an example of the file status after a deletion operation is performed with respect to target data for updating in the first memory unit;

FIG. 7 is a functional block diagram illustrating an exemplary configuration of an information processing device according to a second embodiment;

FIG. 8 is a flowchart for explaining exemplary operations performed by the information processing device according to the second embodiment in the case when a second obtaining unit thereof performs a read ahead operation;

FIG. 9 is a functional block diagram illustrating an exemplary configuration of an information processing device according to a third embodiment and illustrating a configuration surrounding the information processing device;

FIG. 10 is a sequence diagram illustrating the operations performed by the information processing device and a server device according to the third embodiment for the purpose of graph data registration;

FIG. 11 is a block diagram illustrating a simple overview of an information processing device and an information providing device according to a fourth embodiment;

FIG. 12 is a flowchart for explaining an exemplary sequence of operations performed by the information providing device according to the fourth embodiment upon receiving a request for sub-graphs; and

FIG. 13 is a sequence diagram illustrating the operations performed by the information processing device and the information providing device according to the fourth embodiment for the purpose of displaying graph data using auxiliary information.

### DETAILED DESCRIPTION

According to an embodiment, an information processing device includes a first memory, a second memory, a first obtaining unit, a determining unit, and a memory controller. The first memory unit is capable of storing therein graph data which indicates at least either nodes or edges constituting a graph. The second memory unit is capable of storing therein graph data at a faster access speed as compared to the first memory unit. The first obtaining unit obtains relational data which contains relationships that can be converted into at least one graph. The determining unit determines whether to store certain graph data indicating the graph that is converted from the relational data in the first memory unit or in the second memory unit, based on at least any of specification information which specifies a storage destination for certain graph data, or relations of connection with respect to the graph data stored either in the first memory unit or in the second memory unit, and a data size of the relational data. Depending on a determination result of the determining unit, the memory controller stores the certain graph data either in the first memory unit or in the second memory unit.

Various embodiments are described below with reference to the accompanying drawings.

### First Embodiment

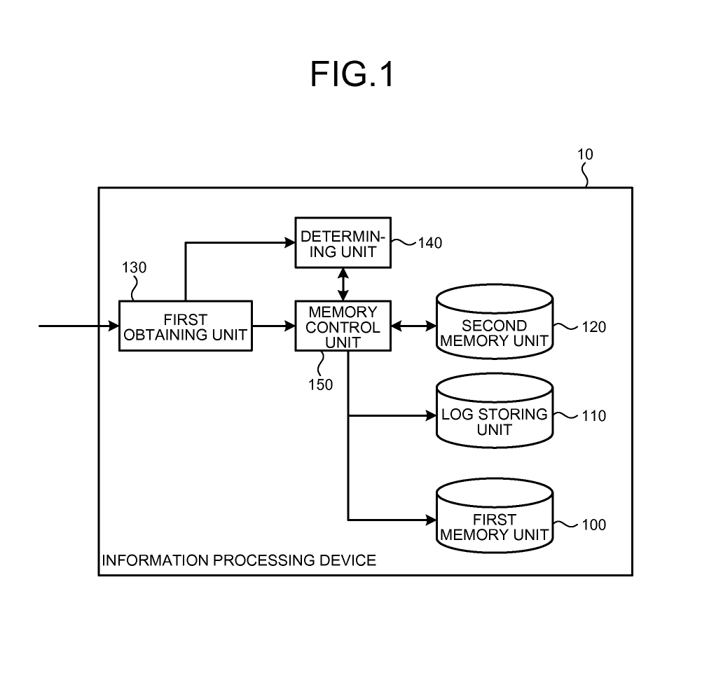

FIG. 1 is a functional block diagram illustrating an exemplary configuration of an information processing device 10 according to a first embodiment. Herein, the information processing device 10 is configured as, for example, a personal computer (PC), a digital television set, a hard disk recorder, or a mobile device such as a tablet PC or a smart phone. That is, the information processing device 10 has the functions of a computer that includes a central processing unit (CPU), a main memory device, an auxiliary memory device, and a communication interface.

As illustrated in FIG. 1, the information processing device 10 includes a first memory unit 100, a log storing unit 110, a second memory unit 120, a first obtaining unit 130, a determining unit 140, and a memory control unit 150. Herein, the determining unit 140 and the memory control unit 150 can be implemented either as hardware circuits or as software running in the CPU.

The first memory unit 100 is used to store graph data that indicates at least either the nodes or the edges constituting a graph. For example, the first memory unit 100 is a nonvolatile auxiliary memory device and is configured with a hard disk drive (HDD), a solid state drive (SSD), a flash memory, or a magnetoresistive random access memory (MRAM). Meanwhile, the first memory unit 100 either can be configured with a single auxiliary memory device or can be configured with a combination of a plurality of auxiliary memory devices.

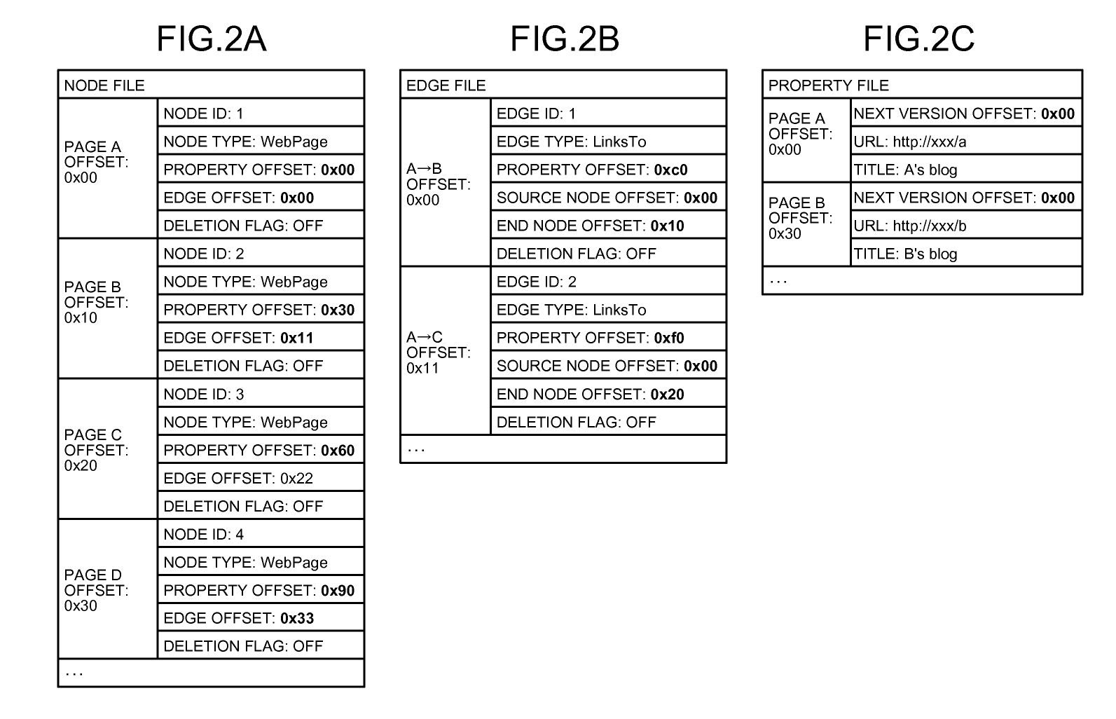

FIGS. 2A to 2C are diagrams illustrating an exemplary storage format (file organization) of the graph data in the first memory unit 100. The first memory unit 100 stores therein the graph data including, for example, Web pages that includes a node file as illustrated in FIG. 2A, an edge file illustrated in FIG. 2B, and a property file as illustrated in FIG. 2C.

The node file contains, for each Web page, a node ID (differentiation information), a node type, a property offset, an edge offset, and a deletion flag. The edge file contains, for each edge (such as A→B), an edge ID, an edge type, a property offset, a source node offset, an end node offset, and a deletion flag. The property file contains, for each Web page, a next version offset, a uniform resource locator (URL), and a title. The files are only exemplary properties in Web page data, and it is possible to set various properties for each target to be managed as graph data.

The log storing unit 110 (FIG. 1) is used to store the graph data for the purpose of ensuring persistence of the log output.

The second memory unit 120 is used to store graph data at a higher access speed as compared to the first memory unit 100. For example, the second memory unit 120 is a volatile main memory device and is configured with a memory such as a dynamic random access memory (DRAM). The graph data stored in the second memory unit 120 can be configured in such a way that the nodes and the edges are materialized including attribute information thereof and are connected by pointers to form a graph structure. Alternatively, the second memory unit 120 can store the graph data in such a way that some part of the graph data (such as the attribute information) is kept stored in the first memory unit 100, and the nodes and the edges are partially materialized by holding address information of the data that is kept stored in the first memory unit 100. Still alternatively, the second memory unit 120 can store the graph data in the format containing node IDs (differentiation information) in an identical manner to the first memory unit 100.

The first obtaining unit 130 obtains relational data having relationships that form the basis for the graph, and outputs the relational data to the memory control unit 150. For example, the relational data points to the browsing history of Web pages using a Web browser, and points to pre-graph-data data having relationships that can be converted into graph data. In the case of converting the Web page browsing history (catalog) into graph data; for example, each page of the Web page catalog is considered to be a node and each link between pages is considered to be an edge. Meanwhile, the first obtaining unit 130 can also be configured to obtain operation settings, which are appended to the relational data and which are used in the determination (described later); and to output the operation settings to the determining unit 140.

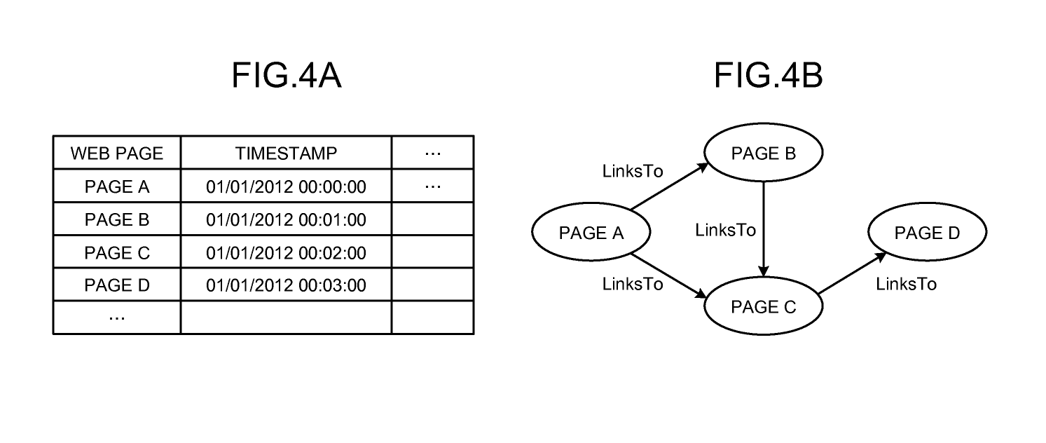

As a specific example, the first obtaining unit 130 reads the Web pages that are cached as the browsing history of the Web browser of the information processing device 10 (such as a PC), and generates and stores a Web graph (see FIG. 4B). For example, the first obtaining unit 130 is implemented as an add-on of the Web browser for making the Web graph viewable as a view. That is, the first obtaining unit 130 is implemented as an application.

The determining unit 140 determines, depending on the operation settings received from the first obtaining unit 130, whether to store the graph data in the first memory unit 100 or in the second memory unit 120. Herein, it is assumed that the operation settings represent control information that enables setting of the storage destination for the graph data based on at least one of the following pieces of information: specification information that specifies the storage destination for the graph data; relations of connection with respect to the graph data stored in the first memory unit 100 or the second memory unit 120; and the data size of the relational data. For example, in contrast to the graph data that is already stored in the second memory unit 120, the determining unit 140 writes the graph data having no relations of connection directly in the first memory unit 100. Meanwhile, the configuration can be such that, with respect to the graph data that is already stored in the second memory unit 120 as well as the graph data that is already in the first memory unit 100, the determining unit 140 refers to the relations of connection.

The memory control unit 150 receives the relational data obtained by the first obtaining unit 130; and, depending on the determination result of the determining unit 140, performs graph data registration by storing the graph data corresponding to the relational data either in the first memory unit 100 or in the second memory unit 120. Moreover, in the case of storing the graph data in the first memory unit 100, the memory control unit 150 either can directly convert the relational data into the graph data format to be stored in the first memory unit 100 or can first convert the relational data into the structure to be held in the second memory unit 120 and then store that structure in the first memory unit 100. Furthermore, the memory control unit 150 can store the graph data while maintaining the order of relational data as it is or can store the graph data in such a way that adjacent nodes (i.e., the nodes close to each other in the accessing order) are placed physically close to each other.

Moreover, with respect to the first memory unit 100, the memory control unit 150 calculates, for example, a write destination address in a nonvolatile memory area. Herein, with respect to the first memory unit 100, the memory control unit 150 appends all pieces of graph data in a predetermined fixed size (i.e., performs total appending). Herein, due to the total appending and the fixed size, writing with respect to the first memory unit 100 is performed at high speed.

Moreover, with respect to the second memory unit 120, the memory control unit 150 instantiates the graph data and establishes connection of the graph data within the second memory unit 120 (in the memory) (i.e., loading in the memory). Herein, the memory control unit 150 refers to the information (such as the node IDs) of the graph data that is already stored in the second memory unit 120 (or in the first memory unit 100 as well as in the second memory unit 120), and prevents duplication of instances of the graph data.

Meanwhile, the memory control unit 150 can also be configured to receive not only the graph data but also storage destination information from the first obtaining unit 130. Moreover, the memory control unit 150 can be configured to process the storage destination information and the graph data in an independent manner.

As a specific example, the memory control unit 150 points to a registration-related application program interface (API) of a graph database library and the internal processing of that API. The memory control unit 150 can be configured to enable specification of the storage destination information as an argument of open processing of the graph database, or can be configured to enable specification of the storage destination information as an argument of registration-related operations such as new insertion, updating, and deletion. For example, the storage destination information contains information that enables determination of whether to operate the graph database as an in-memory database (i.e., whether to store the graph database always in the second memory unit 120) or to operate the graph database as a file database (i.e., whether to store the graph database in the first memory unit 100). Moreover, the storage destination information can also contain path information of a file or a directory in the case of using the first memory unit 100 as a file database.

Meanwhile, the configuration of the information processing device 10 can be such that the memory control unit 150, the first memory unit 100, and the second memory unit 120 are connected via an internal network. In this case, the storage destination information can contain the IP address or the host name, the port number, and the database user ID or confidential information. Moreover, the storage destination information is not mandatory, and the configuration can be such that the determining unit 140 always performs determination according to some of the information.

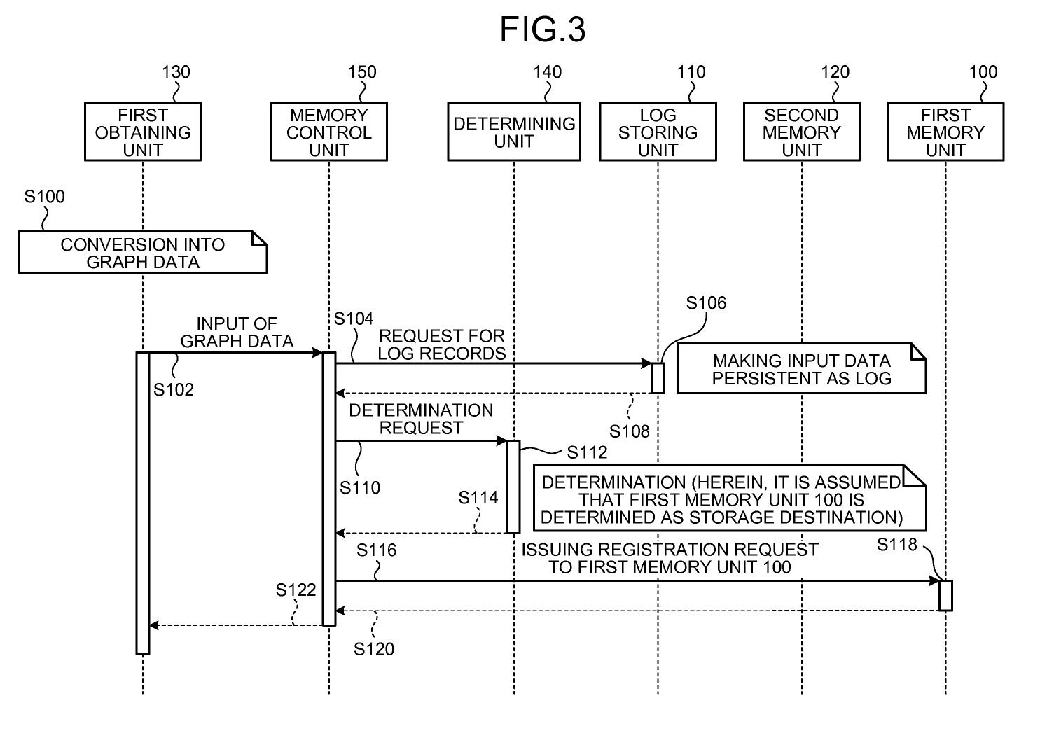

Given below is the explanation of the operations performed by the information processing device 10. FIG. 3 is a sequence diagram illustrating an example of the operations performed by the information processing device 10 for the purpose of graph data registration. FIGS. 4A and 4B are conceptual diagrams that conceptually illustrate an example of the relational data obtained by the first obtaining unit 130 of the information processing device 10.

As illustrated in FIG. 3, the first obtaining unit 130 obtains, as relational data, a list of Web pages (see FIG. 4A) that is stored as, for example, the Web browsing history. The first obtaining unit 130 converts the list of Web pages into graph data by considering the Web pages in the list of Web pages as nodes and considering the inter-page links as edges (see FIG. 4B) (Step S100).

Then, the first obtaining unit 130 inputs the graph data to the memory control unit 150 (Step S102). Subsequently, the memory control unit 150 requests the log storing unit 110 for log records (Step S104). Herein, the log storing unit 110 stores the input data (the graph data) as a log with the aim of recovering that data in case of trouble (Step S106). That is, the log storing unit 110 makes the graph data persistent.

Then, the log storing unit 110 notifies the memory control unit 150 about completing the storing of graph data (Step S108). Subsequently, the memory control unit 150 issues a request to the determining unit 140 to determine the storage destination for the graph data (i.e., issues a determination request) (Step S110).

Then, according to the operation settings (the control information) described above, the determining unit 140 determines whether to store the graph data in the first memory unit 100 or in the second memory unit 120 (Step S112). In the example illustrated in FIG. 3, it is assumed that the determining unit 140 determines to store the graph data in the first memory unit 100. Then, the determining unit 140 notifies the memory control unit 150 about the determination result (Step S114).

Subsequently, the memory control unit 150 issues a graph data registration request to the first memory unit 100 (Step S116). Accordingly, the first memory unit 100 stores therein the graph data (Step S118). Then, the first memory unit 100 notifies the memory control unit 150 about completing the storing of the graph data (Step S120). In turn, the memory control unit 150 notifies the first obtaining unit 130 about completing the registration of the graph data (Step S122).

Given below is the explanation regarding the control (file organization) performed by the memory control unit 150 so as to make the first memory unit 100 store therein the graph data. Herein, the memory control unit 150 performs control in such a way that the first memory unit 100 performs new insertion of graph data, updating of graph data, or deletion of graph data. Meanwhile, it is assumed that the information other than the properties of nodes and edges is not modified, and the modification occurs only regarding the properties of nodes and edges. Moreover, it is assumed that the nodes and the edges are only either newly inserted (added) or deleted.

New insertion: see FIGS. 2A to 2C

Firstly, in the case in which graph data is newly inserted in the first memory unit 100, the memory control unit 150 calculates in advance address information (writing position information) in the first memory unit 100 according to a predetermined writing order. Herein, the address information represents the writing position information in the first memory unit 100 and points to, for example, the offset from the top of a file or the offset from the top of a page (where a page is the unit of reading from a nonvolatile memory area to a volatile memory area).

Then, at the end of each file, the memory control unit 150 appends the properties of nodes and edges. That is, in the case of new insertion of graph data, the memory control unit 150 newly appends the graph data without overwriting any nodes, edges, or properties in the first memory unit 100 (i.e., performs total appending). Herein, the information indicating the nodes that are included in the edges and that constitute the edges is considered to be the address information calculated in advance.

Meanwhile, in the case of new insertion of graph data in the first memory unit 100, following two areas are provided in preparation for future updating or future deletion of the graph data: “next version address (see FIG. 2C)” and “deletion flag (see FIG. 2A)”.

The “next version address” points to an area that is used to store the writing start position of the next version of graph data during the process of updating the graph data in future. For example, the area of “next version address” can include writing start position (file offset) information as well as timestamp information or version information (transaction identification information). Moreover, in order to indicate the latest entry, the “next version address” has information indicating an empty address (for example, filled with “0”) written therein.

The “deletion flag” points to an area that is used to store data indicating whether or not a node or an edge is a deleted node or a deleted edge. For example, the area of “deletion flag” can include a flag of Boolean values as well as timestamp information or version information (transaction identification information).

Updating

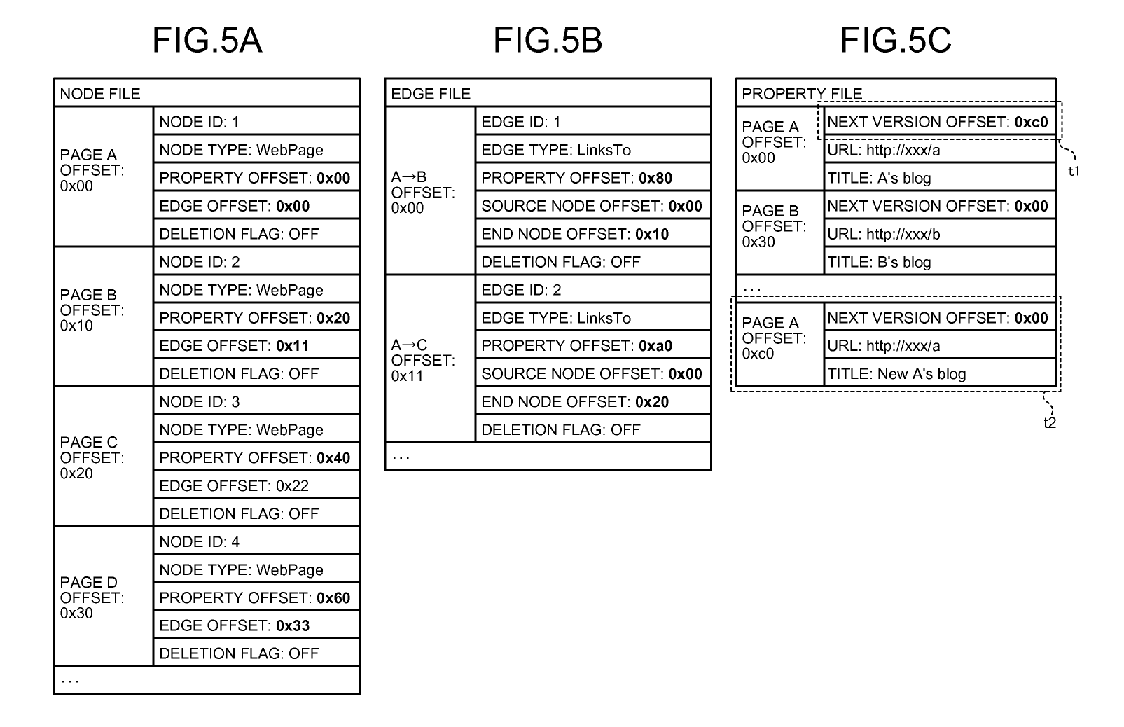

When the next version address (for example, the next version offset) is written in the graph data stored in the first memory unit 100, the memory control unit 150 regards that the graph data is updated. FIGS. 5A to 5C are diagrams illustrating an example of the file status after a graph data updating operation is performed in the first memory unit 100. In FIG. 5A, it is illustrated that the property of the node of a Web page (i.e., the title of a Web page) is modified.

When the graph data is updated, the address information calculated at the time of new insertion is included in target data (nodes/edges) for updating. Once the graph data is updated, the appending position of the updating data (the end of the file) is written at the next version address that was an empty address prior to performing updating. In the updating data at the appending position; firstly an empty next version address is written to indicate that the entry is the latest entry, and then the updating information of the properties is appended.

For example, as illustrated in FIG. 5, in the updated node (Web page A) having an offset value “0x00” in the property file, an offset value “0xc0” that is calculated as the address information is included in a next version address t1 (next version offset). When the graph data is updated, the next version address is tracked from the address information serving as the origin until the next version address becomes an empty address. For example, regarding a page A (t2) having the offset value “0xc0”, the next version address (the next version offset) is an empty address “0x00”. That is, the Web page A (t2) having the offset value “0xc0” points to the Web page A being the latest entry after updating.

Deletion

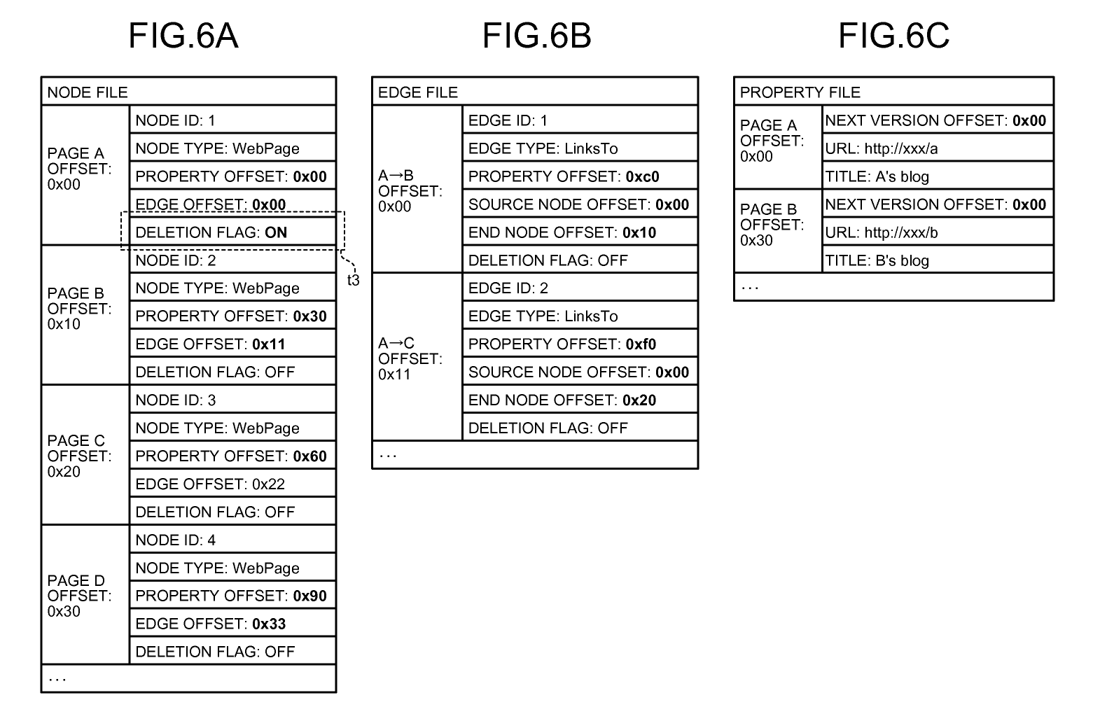

When the deletion flag of target data for updating (node/edge), which is stored in the first memory unit 100, is switched to ON; the memory control unit 150 regards that the target data for updating is deleted. FIGS. 6A to 6C are diagrams illustrating an example of the file status after a deletion operation is performed with respect to the target data for updating in the first memory unit 100. In FIG. 6A, it is illustrated that the node of the page is deleted.

When a node is deleted, the deletion flag of the target data for updating is switched to ON. Since the target data for updating includes the address information calculated at the time of new insertion; the address information serves as the origin in identifying the position of the deletion flag that has been switched to ON.

Meanwhile, the abovementioned files stored in the first memory unit 100 are three differently files respectively storing the nodes, the edges, and the properties. However, alternatively, it is possible to organize only a single file containing the nodes, the edges, as well as the properties. Still alternatively, it is possible to set an upper limit to the size of a file or an upper limit to the storable number of nodes or the storable number of edges count in a file, and the file can be divided into a plurality of files. Still alternatively, a file can be divided according to the node types or the edge types.

Moreover, in order to enable high-speed execution of various queries with respect to the graph data, a file can be organized to include a plurality of index files in each of which a graph index (including a path index) is written that is used in, for example, identifying sub-graphs or obtaining the scope of the stored graph. Meanwhile, in the organization of files stored in the first memory unit 100 as illustrated in FIG. 2, it is assumed that all properties are appended. However, alternatively, the configuration can be such that only the modified portion is appended.

In this way, in the information processing device 10 according to the first embodiment, file organization includes total appending without performing reallocation (overwriting) of nodes or edges (except properties) in the first memory unit 100. Hence, it becomes possible to achieve a high writing throughput while performing new insertion, updating, or deletion of the graph data.

Moreover, in the information processing device 10 according to the first embodiment, the determination of whether to store the graph data, which is obtained from the relational data, in the first memory unit or in the second memory unit is based on at least one of the following pieces of information: specification information that specifies the storage destination for the graph data; relations of connection with respect to the graph data stored in the first memory unit or the second memory unit; and the data size of the relational data. As a result, it becomes possible to achieve a sufficient throughput with respect to the graph data that indicates at least either the nodes or the edges constituting a graph.

### Second Embodiment

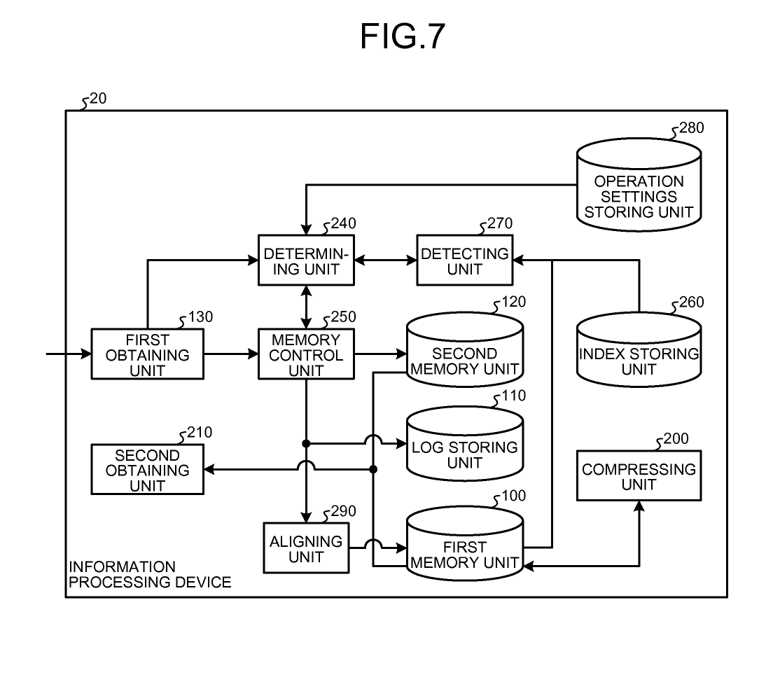

FIG. 7 is a functional block diagram illustrating an exemplary configuration of an information processing device 20 according to a second embodiment. Herein, the information processing device 20 is configured as, for example, a PC, a digital television set, a hard disk recorder, or a mobile device such as a tablet PC or a smart phone. That is, the information processing device 20 has the functions of a computer that includes a CPU, a main memory device, an auxiliary memory device, and a communication interface.

As illustrated in FIG. 7, the information processing device 20 includes the first memory unit 100, the log storing unit 110, the second memory unit 120, the first obtaining unit 130, a determining unit 240, a memory control unit 250, an index storing unit 260, a detecting unit 270, an operation settings storing unit 280, an aligning unit 290, a compressing unit 200, and a second obtaining unit 210. Meanwhile, in the information processing device 20 illustrated in FIG. 7, the constituent elements that are substantively identical to the constituent elements in the information processing device 10 illustrated in FIG. 1 are referred to by the same reference numerals.

The index storing unit 260 is used to store index information such as range information that indicates the range of the entire existing graph data stored in the first memory unit 100 or the second memory unit 120, or range information of the graph data stored in more granular portions.

The detecting unit 270 compares the graph data that is input to the memory control unit 250 with the existing graph data that is stored in the first memory unit 100 or the second memory unit 120, and detects duplication of instances of the graph data. The detecting unit 270 can be configured to detect duplications by performing data matching of each piece of graph data, or can be configured to detect duplications using the index information of the index storing unit 260.

The operation settings storing unit 280 is used to store, in advance, storage destination information that indicates whether to store the graph data, which is input to the memory control unit 250, in the first memory unit 100 or in the second memory unit 120. The storage destination information is used by the determining unit 240 to determine whether to store the graph data in the first memory unit 100 or in the second memory unit 120. However, in place of the storage destination information, the operation settings storing unit 280 can store therein some other information that can be used by the determining unit 240 to perform the determination. For example, in place of the storage destination information, the operation settings storing unit 280 can either store the size of the input graph data or store a threshold value of the size of the graph data that is stored in the second memory unit 120.

Thus, in addition to the function of the determining unit 140, the determining unit 240 also has the function of referring to the detection result of the detecting unit 270 and the storage destination information stored in the operation settings storing unit 280 and accordingly determining whether to store the graph data in the first memory unit 100 or in the second memory unit 120. For example, if the detection result of the detecting unit 270 indicates that there is no duplications, then the determining unit 240 determines to store the graph data in the first memory unit 100; while if the detection result of the detecting unit 270 indicates that there are duplications, then the determining unit 240 determines to store the graph data in the second memory unit 120. Alternatively, the determining unit 240 can also be configured to perform determination according to the number of duplications.

The aligning unit 290 aligns the input graph data according to a predetermined specific alignment strategy and then writes the aligned graph data in the first memory unit 100. The alignment strategy can be included in the input data of the memory control unit 250, or can be stored in the operation settings storing unit 280, or can be a fixed strategy. Meanwhile, the alignment strategy can be, for example, a breadth first search sequence or a depth first search sequence with a specific node as the origin. Moreover, the search sequence indicated by the alignment strategy can be determined according to the upper limit of the search hop count, the attribute values of nodes and edges, and classification information and attribute information of nodes and edges.

The compressing unit 200 compresses the size of the graph data in the first memory unit 100 by performing the following operations: deleting such node information and edge information in the first memory unit 100 which has the deletion flag set to ON; deleting the property information of old versions; and keeping only the valid graph data. Moreover, the compressing unit 200 updates the edge information connected to the deleted nodes as well as updates the neighboring node information with respect to the deleted nodes. Herein, the compressing unit 200 can perform the compression in response to a compression request issued explicitly from an application via the memory control unit 250, or can perform the compression as internal processing on a periodic basis. Alternatively, the compressing unit 200 can be configured to have a threshold value for the deletion amount (count) of the graph data or a threshold value for the total data volume (count) of the graph data, and to perform the compression if the threshold value is exceeded.

The second obtaining unit 210 searches for the graph data based on a query issued thereto, and obtains a result corresponding to the query. For example, the second obtaining unit 210 is an API related to the reading of the graph database library. A query points to a search request issued for obtaining a specified node, a specified edge, or a specified sub-graph. Alternatively, a query can also be a search request issued for scanning neighboring edges or neighboring nodes from a specified node according to a specified search strategy (such as the search sequence or the type/attribute condition to be searched).

In the case of searching in the first memory unit 100 for the graph data in response to a search request, the second obtaining unit 210 can be configured to read ahead a certain volume of data based on the search strategy. Such a read ahead operation can be performed on the premise of the alignment strategy of the aligning unit 290 and by collectively obtaining a certain size of memory area of the first memory unit 100.

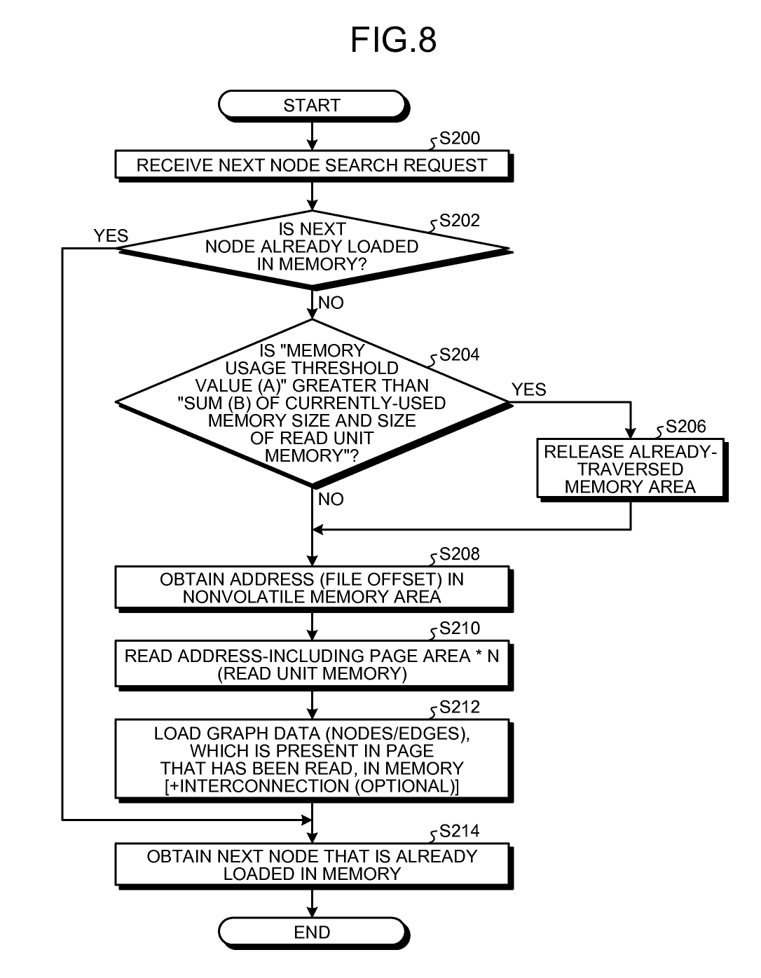

FIG. 8 is a flowchart for explaining the operations performed by the information processing device 20 in the case when the second obtaining unit 210 performs the read ahead operation. As illustrated in FIG. 8, the memory control unit 250 receives a next node search request (Step S200).

Then, the memory control unit 250 determines whether or not the next node is already loaded in the second memory unit 120 (Step S202). If the next node is already loaded in the second memory unit 120 (Yes at Step S202); then the system control proceeds to Step S214. On the other hand, if the next node is not already loaded in the second memory unit 120 (No at Step S202); then the system control proceeds to Step S204.

At Step S204, the memory control unit 250 determines whether or not the sum (B) of the currently-used memory size (i.e., the area of use of the second memory unit 120) and the size of a read unit memory is smaller than a memory usage threshold value (A) (Step S204). If it is determined that B is smaller than A (Yes at Step S204), then the system control proceeds to Step S206. On the other hand, if it is determined that B is not smaller than A (No at Step S204), then the system control proceeds to Step S208.

At Step S206, the memory control unit 250 releases the already-traversed memory area in the second memory unit 120 (Step S206).

At Step S208, the memory control unit 250 obtains an address in the nonvolatile memory area (i.e., obtains a file offset) in the first memory unit 100 (Step S208).

Then, as the unit of reading with respect to the second memory unit 120, the memory control unit 250 reads a page area including addresses (Step S210).

Subsequently, the memory control unit 250 loads the graph data (nodes/edges), which is present in the page that has been read, in the memory (in the second memory unit 120) (Step S212). Moreover, the memory control unit 250 can also perform interconnection of the graph data (optional).

Then, the memory control unit 250 obtains the next node that is already loaded in the second memory unit 120 (Step S214).

In this way, in the information processing device 20 according to the second embodiment, in the case when it takes time in determining the storage destination, such as in the case when duplication of the existing graph data is found or when the input graph data is large in size; the index storing unit 260 can reduce the processing amount involved in the determination operation. Moreover, in the information processing device 20, even in the case of searching for the graph data in the first memory unit 100, the coordination between the aligning unit 290 and the second obtaining unit 210 enables achieving reduction in the number of input-output operations with respect to the second memory unit 120 by means of a read ahead operation. As a result, it becomes possible to perform the search operations at high speed. Furthermore, in the information processing device 20, the compression of the graph data performed by the compressing unit 200 enables achieving prevention of monotonic increase in the graph data.

### Third Embodiment

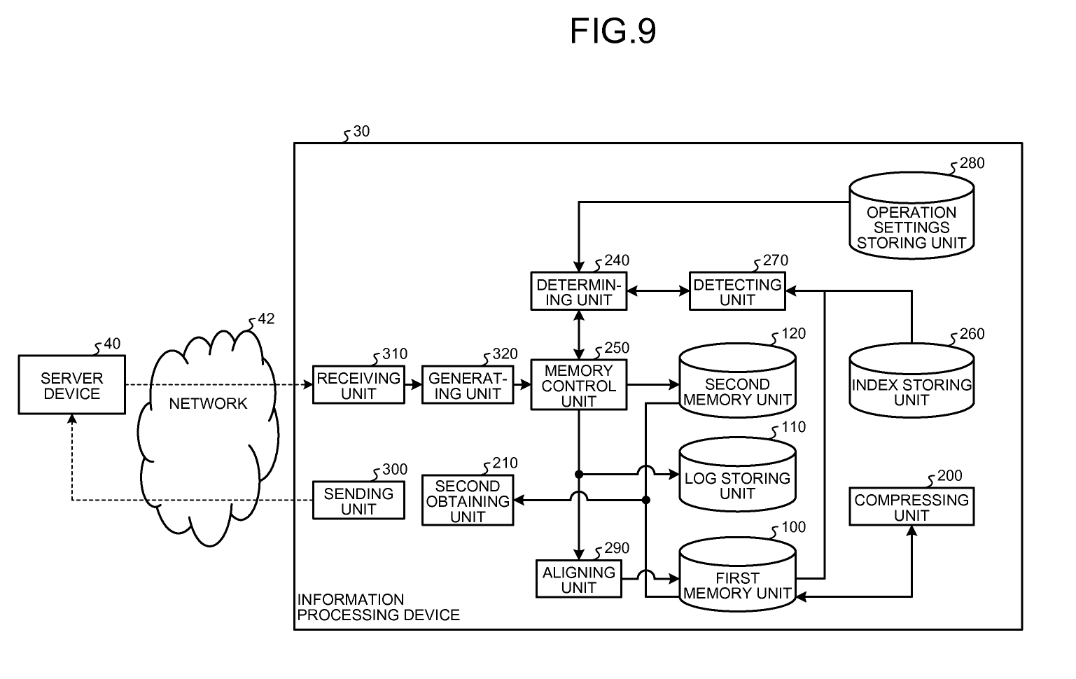

FIG. 9 is a functional block diagram illustrating an exemplary configuration of an information processing device 30 according to a third embodiment and illustrating a configuration surrounding the information processing device 30. Herein, the information processing device 30 is configured as, for example, a personal computer (PC), a digital television set, a hard disk recorder, or a mobile device such as a tablet PC or a smart phone. That is, the information processing device 30 has the functions of a computer that includes a central processing unit (CPU), a main memory device, an auxiliary memory device, and a communication interface.

As illustrated in FIG. 9, the information processing device 30 is connected to a server device 40 via a network 42. Herein, the network 42 can be the Internet, or a wide area network (WAN) such as a next generation network (NGN) that is a closed network having quality assurance, or a local area network such as a home network configured with various wireless/wired connections, or a wide area broadcast such as a regular broadcast or cable television (CATV). Herein, it is assumed that the network 42 points to the Internet.

The server device 40 is an information providing device that provides data, which is stored in the first memory unit 100 or the second memory unit 120 by the information processing device 30, via the network 42. For example, the server device 40 is a server device of a Web service provider that provides Web services over the Internet.

The information processing device 30 includes the first memory unit 100, the log storing unit 110, the second memory unit 120, the determining unit 240, the memory control unit 250, the index storing unit 260, the detecting unit 270, the operation settings storing unit 280, the aligning unit 290, the compressing unit 200, the second obtaining unit 210, a sending unit 300, a receiving unit 310, and a generating unit 320. Meanwhile, in the information processing device 30 illustrated in FIG. 9, the constituent elements that are substantively identical to the constituent elements in the information processing device 20 illustrated in FIG. 7 are referred to by the same reference numerals.

The sending unit 300 sends a request message, which is used to request for sending of the data stored in the first memory unit 100 or the second memory unit 120, to the server device 40 via the network 42. The request message can be sent as a result of a user operation with respect to the information processing device 30 or can be sent by the information processing device 30 on a periodic basis. For example, the request message is a Web API of the commonly-used REST format (REST stands for REpresentational State Transfer). Moreover, it is assumed that the request message can contain information indicating the source node of a graph; information indicating the number of hops from the source node; information indicating the search method; classification information distinguished according to types of the nodes and the edges indicated by the graph data; attribute information used in identifying the attributes of nodes and edges; and response order information that indicates a response order based on at least either the classification information regarding nodes and edges or the attribute information regarding nodes and edges.

The data requested by the information processing device 30 can be any one of the following: the data constituting the graph data or can be the data (relational data) that enables generation of graph data using the information included in the request message; the graph data that is already stored in the first memory unit 100 or the second memory unit 120; and any other data stored in the information processing device 30.

The receiving unit 310 receives the data from the server device 40 via the network 42. The received data either can be the data constituting the graph data or can be the relational data. The receiving unit 310 outputs the received relational data to the generating unit 320. Meanwhile, in the case when graph data is received, the receiving unit 310 can output the graph data to the memory control unit 250.

The generating unit 320 generates graph data from the relational data received by the receiving unit 310. Herein, the generating unit 320 generates graph data using the information included in the request message, or using the graph data that is already stored in the first memory unit 100 or the second memory unit 120, or using any other data stored in the information processing device 30.

For example, the generating unit 320 is a node/edge generation API in the graph database library that is considered to be equivalent to the memory control unit 250 or the second obtaining unit 210. As a specific example, in a social networking service (SNS), the generating unit 320 obtains the friends list of a particular user via Web APIs and generates friendship edges that connect the particular user with the users included in the friends list. Moreover, for example, with respect to a Web page, the generating unit 320 refers to the data quoted by a particular user in blogs or micro-blogs and generates reference edges that connect the particular user to Web contents.

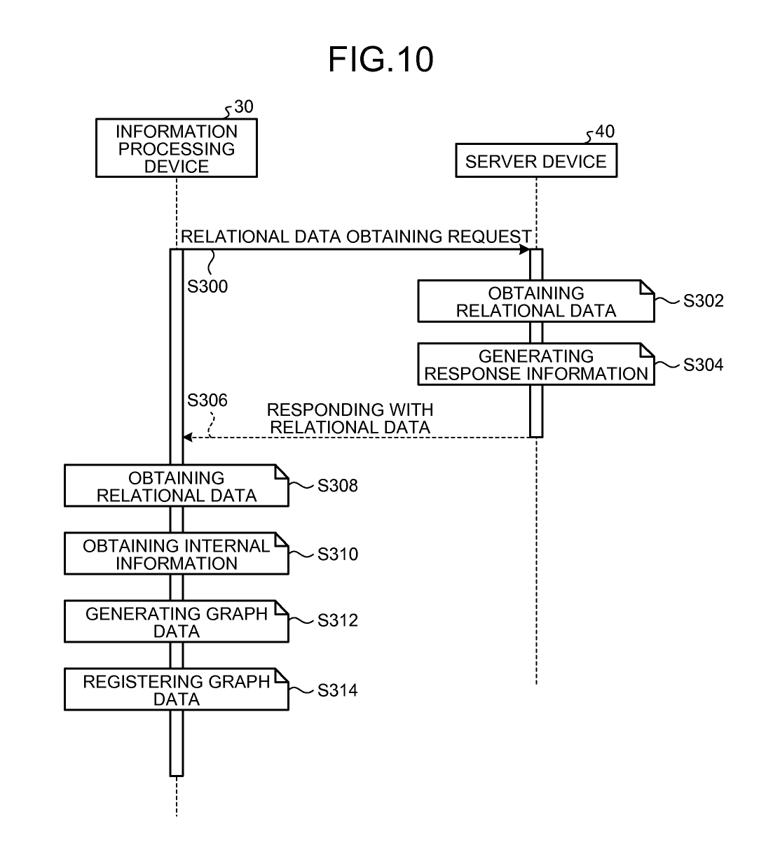

Given below is the explanation of a communication sequence between the information processing device 30 and the server device 40 for the purpose of graph data registration. FIG. 10 is a sequence diagram illustrating the operations performed by the information processing device 30 and the server device 40 for the purpose of graph data registration.

As illustrated in FIG. 10, the information processing device 30 requests the server device 40 to obtain relational data (Step S300).

Then, the server device 40 obtains relational data in preparation for sending the relational data to the information processing device 30 (Step S302).

Subsequently, the server device 40 generates response information that contains the relational data (Step S304).

Then, the server device 40 responds to the information processing device 30 with the response information that contains the relational data (Step S306).

Subsequently, the information processing device 30 obtains the relational data from the response information that is received from the server device 40 (Step S308).

Then, in preparation for generating graph data, the information processing device 30 obtains the graph data that is already stored in the first memory unit 100 or in the second memory unit 120, or obtains the other data (internal information) that is stored in the information processing device 30 (Step S310).

Subsequently, the information processing device 30 generates graph data using the relational data obtained at Step S308 and using the internal information obtained at Step S310 (Step S312).

Then, under the control of the memory control unit 250, the information processing device 30 performs graph data registration by storing the graph data either in the first memory unit 100 or in the second memory unit 120 (Step S314).

In this way, in the information processing device 30 according to the third embodiment, even if relational data originally having no graph structure is received, the generating unit 320 can generate graph data and register the graph data. Moreover, in the information processing device 30, it is also possible to integrate the data of a plurality of Web services and create a single piece of graph data.

### Fourth Embodiment

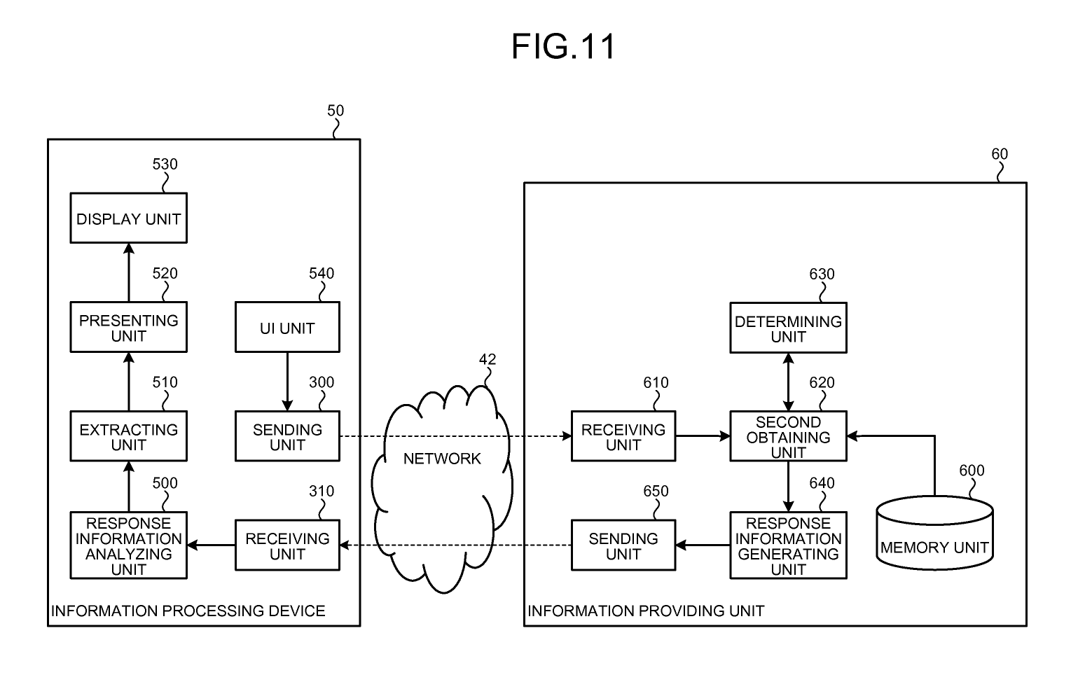

FIG. 11 is a block diagram illustrating a simple overview of an information processing device 50 and an information providing device 60 according to a fourth embodiment. Herein, the information processing device 50 is configured as, for example, a personal computer (PC), a digital television set, a hard disk recorder, or a mobile device such as a tablet PC or a smart phone. That is, the information processing device 50 has the functions of a computer that includes a central processing unit (CPU), a main memory device, an auxiliary memory device, and a communication interface.

As illustrated in FIG. 11, the information processing device 50 is connected to the information providing device 60 via the network 42. Herein, it is assumed that the information processing device 50 is equipped with all functions of the information processing device 30. Meanwhile, in the information processing device 50 and the network 42 illustrated in FIG. 11, the constituent elements that are substantively identical to the constituent elements illustrated in FIG. 9 are referred to by the same reference numerals.

The information providing device 60 has the same hardware configuration as the hardware configuration of, for example, the server device 40 illustrated in FIG. 9. Thus, the information providing device 60 provides Web services over the Internet. However, herein, the information providing device 60 provides not the relational data but the graph data to the information processing device 50.

The information providing device 60 includes a memory unit 600, a receiving unit 610, a second obtaining unit 620, a determining unit 630, a response information generating unit 640, and a sending unit 650. The memory unit 600 stores graph data. Herein, the memory unit 600 functions as a storage processing unit that stores a graph database in the first memory unit 100 and the second memory unit 120 of the information processing device 50.

The receiving unit 610 receives a query regarding graph data from the information processing device 50. As a specific example, the receiving unit 610 functions as a request receiving unit of an HTTP server (HTTP stands for HyperText Transfer Protocol). Alternatively, the receiving unit 610 can be configured to perform communication using other protocols such as WebSocket.

Herein, it is assumed that a query includes a message that identifies a certain node, a certain edge, or a certain sub-graph from the graph data stored in the memory unit 600. Moreover, a query can also include information for identifying a display order of graph data in the information processing device 50 (display order identification information).

The second obtaining unit 620 obtains, from the memory unit 600, the graph data that corresponds to the query received by the receiving unit 610. Thus, the second obtaining unit 620 is an identical functional block to the second obtaining unit 210 of the information processing device 20.

Moreover, the second obtaining unit 620 can obtain the graph data based on the display order in the information processing device 50. In that case, the second obtaining unit 620 can refer to the display order identification information included in the query or can refer to order information that is determined in advance in an information processing system (or an application) that is configured with the information providing device 60 and the information processing device 50.

Furthermore, the second obtaining unit 620 can also obtain a larger piece of relational data that includes the relational data defined by the query. For example, in the case when it is extremely time consuming to generate a response message corresponding to the query, the information providing device 60 transfers some part of the graph data generating operation to the information processing device 50. As a specific example, in a query for extracting a sub-graph that is formed with a set of nodes equivalent to N number of hops from the source node, if it takes a lot of time to perform trimming of the edges of the leaf node (the node at the N-th hop); then the information providing device 60 transfers the operation of trimming the edges of the leaf node to the information processing device 50.

The determining unit 630 determines whether or not it is necessary (or whether or not it is possible) to transfer some operations to the information processing device 50 according to the response time or the volume of graph data in the case when the second obtaining unit 620 obtains graph data from the memory unit 600. Depending on the determination result of the determining unit 630, the second obtaining unit 620 obtains different pieces of data.

The response information generating unit 640 generates a response message (response information) from the graph data obtained by the second obtaining unit 620, and outputs the response message to the sending unit 650. For example, the response message is stored in the body of an HTTP response. Moreover, the response message contains, for example, information indicating the source node of a graph; information indicating the number of hops from the source node; information indicating the search method; classification information distinguished according to types of the nodes and the edges indicated by the graph data; attribute information used in identifying the attributes of nodes and edges; and information that indicates a display order based on at least either the classification information regarding nodes and edges or the attribute information regarding nodes and edges. The response message has a format such as XML or JSON that is highly compatible with the Web. However, as long as the format is interpretable by the information processing device 50, any format including the binary format can be used.

Meanwhile, the response information generating unit 640 is configured to be able to include, in the response information, auxiliary information that is used in extracting the graph data, which is defined by the query (for example, graph data indicating sub-graphs), in the information processing device 50 (i.e., on the terminal side). For example, the auxiliary information contains distance information from the central node at which edge trimming is not done or contains trimming rule information. Meanwhile, the response information generating unit 640 can output the sub-graphs corresponding to the query to the sending unit 650 not in a collective manner but in a stepwise manner, and can perform operations in such a way that the information processing device 50 displays the graph in an incremental manner from the generated sub-graphs.

The sending unit 650 sends the response message, which is generated by the response information generating unit 640, to the information processing device 50. More particularly, the sending unit 650 is a response sending unit of an HTTP server. Alternatively, the sending unit 650 can be configured to perform communication using other protocols such as WebSocket.

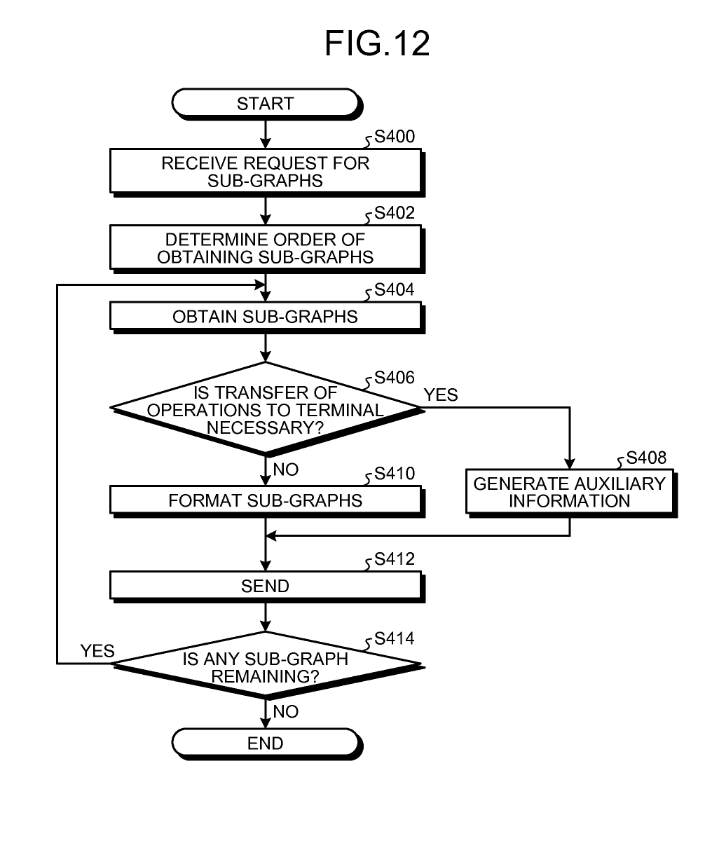

Given below is the explanation regarding the operations performed by the information providing device 60. FIG. 12 is a flowchart for explaining an exemplary sequence of operations performed by the information providing device 60 upon receiving a request for sub-graphs. As illustrated in FIG. 12, the information providing device 60 receives a request (a request message) for sub-graphs (Step S400).

Then, the information providing device 60 determines the order of obtaining the sub-graphs (Step S402).

Subsequently, the information providing device 60 obtains the sub-graphs (Step S404).

Then, the information providing device 60 determines whether or not it is necessary to transfer some operations to the information processing device 50 (the terminal) (Step S406). If it is determined to be necessary to transfer some operations (Yes at Step S406); then the system control proceeds to Step S408. On the other hand, if it is determined not to be necessary to transfer some operations (No at Step S406); then the system control proceeds to Step S410.

At Step S408, the information providing device 60 generates auxiliary information that is used in extracting the graph data, which is defined by the query, in the information processing device 50 (i.e., on the terminal side) (Step S408).

At Step S410, the information providing device 60 formats the sub-graphs for the purpose of sending them (Step S410).

Then, the information providing device 60 sends the sub-graphs formatted at Step S410 or the auxiliary information generated at Step S408 to the information processing device (Step S412).

Subsequently, the information providing device 60 determines whether or not there are any remaining sub-graphs that need to be sent (Step S414). If there are remaining sub-graphs that need to be sent (Yes at Step S414), then the system control returns to Step S404. On the other hand, if there are no remaining sub-graphs that need to be sent (No at Step S414); then that marks the end of the operations.

Given below is the detailed explanation regarding the information processing device 50 (FIG. 11). As described above, the information processing device 50 is equipped with all functions of the information processing device 30. In addition, the information processing device 50 includes a response information analyzing unit 500, an extracting unit 510, a presenting unit 520, a display unit 530, and a user interface (UI) unit 540.

The response information analyzing unit 500 analyzes the response information in the case when the graph data needs to be extracted in the information processing device 50. The extracting unit 510 refers to the auxiliary information included in the response information that has been analyzed by the response information analyzing unit 500, and extracts the graph data of sub-graphs. That is, in the case when response information is received that contains information indicating sub-graphs which match the request message, the information processing device 50 generates the graph data of those sub-graphs from the response information by referring to the auxiliary information.

The presenting unit 520 displays, on the display unit 530, the sub-graphs from which the extracting unit 510 extracted graph data. For example, the presenting unit 520 corresponds to an output function in a Web browser for outputting data to a rendering engine. Alternatively, the presenting unit 520 can sequentially output the sub-graphs, which are sent from the information providing device 60 in a stepwise manner, to the display unit 530. In that case, the display unit 530 performs an incremental display based on the display order in accordance with the output of the presenting unit 520. For example, from a central user in an SNS, the display unit 530 displays the friends at the first hop, the friends at the second hop, the friends at the third hop, and so on. The UI unit 540 is a user interface that, for example, enables sending of request messages to the sending unit 300.

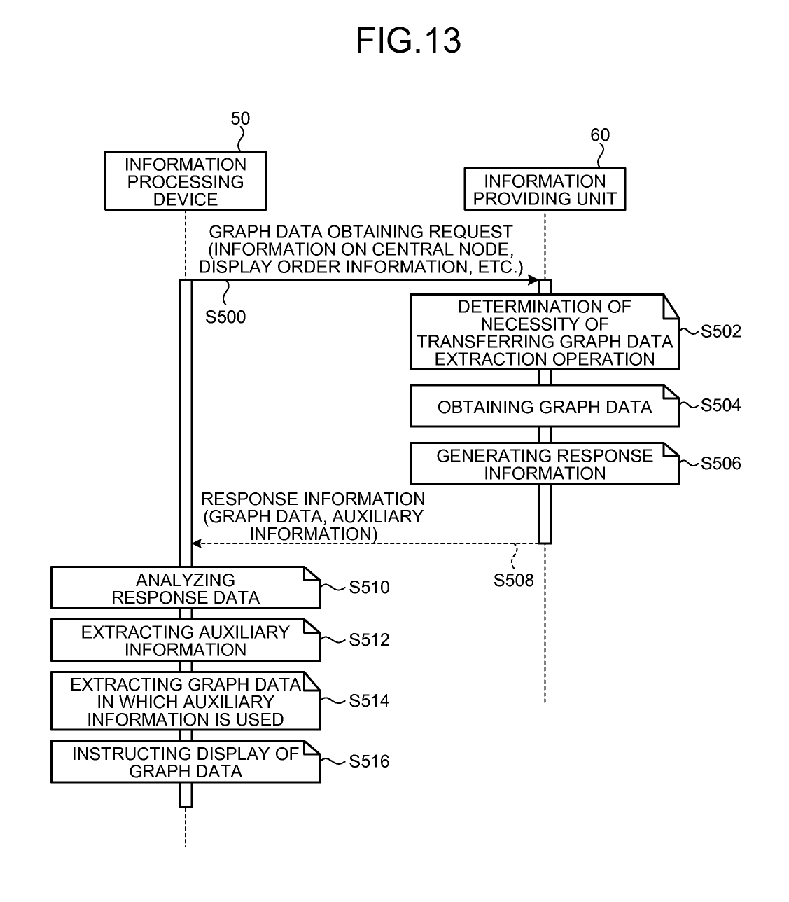

Given below is the explanation of a communication sequence between the information processing device 30 and the server device 40 for the purpose of displaying graph data using auxiliary information. FIG. 13 is a sequence diagram illustrating the operations performed by the information processing device 50 and the information providing device 60 for the purpose of displaying graph data using auxiliary information.

As illustrated in FIG. 13, the information processing device 50 issues a request for obtaining graph data (issues a graph data obtaining request to the information providing device 60 (Step S500). That is, through the graph data obtaining request, the information processing device 50 requests for the information on the central node and the display order information.

Then, the determining unit 630 of the information providing device 60 determines whether or not it is possible (or whether or not it is necessary) to transfer the operation of extracting the graph data (Step S502).

Subsequently, the second obtaining unit 620 obtains graph data in preparation for sending it (Step S504).

Then, the response information generating unit 640 generates response information (Step S506).

Subsequently, the sending unit 650 sends the response information, which is generated at Step S506, to the information processing device 50 (Step S508). Herein, the response information contains auxiliary information. Moreover, the response information can also contain graph data. In this way, the information providing device 60 gives a graph data response to the graph data obtaining request received from the information processing device 50.

Then, the response information analyzing unit 500 of the information processing device 50 refers to the response information received from the information providing device 60 and performs data analysis with respect to the response received from the information providing device 60 (Step S510).

Subsequently, the extracting unit 510 extracts auxiliary information from the response information (Step S512).

Then, the extracting unit 510 extracts graph data in which the auxiliary information is used (Step S514).

Subsequently, the presenting unit 520 instructs the display unit 530 to display the graph data (Step S516).

In this way, according to the fourth embodiment, even when the sub-graphs are large in size or when it is difficult to calculate the sub-graphs in advance, the information providing device 60 transfers the operation of extracting graph data to the information processing device 50. As a result, sub-graphs including edges can be displayed at such a speed that there is no loss in the user experience.

Meanwhile, an information processing program executed in the information processing device according to the embodiments is recorded in the form of an installable file or an executable file in a computer-readable recording medium such as a compact disk read only memory (CD-ROM), a flexible disk (FD), a compact disk readable (CD-R), or a digital versatile disk (DVD).

Alternatively, the information processing program executed in the information processing device according to the embodiments can be saved as a downloadable file on a computer connected to the Internet or can be made available for distribution through a network such as the Internet.

Still alternatively, the information processing program executed in the information processing device according to the embodiments can be stored in advance in a read only memory (ROM) or the like. Moreover, the information processing program executed in the information processing device according to the embodiments contains a module for each of the abovementioned constituent elements to be implemented in a computer. In practice, for example, a CPU (processor) reads the information processing program from the recording medium and runs it such that the information processing program is loaded in a main memory device. As a result, the module for each of the abovementioned constituent elements is generated in the main memory device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a first memory unit configured to be capable of storing therein graph data which indicates at least either nodes or edges constituting a graph;
a second memory unit configured to be capable of storing therein graph data at an access speed faster than an access speed of the first memory unit;
a first obtaining unit configured to obtain relational data which contains relationships that can be converted into at least one graph;
a determining unit configured to determine whether to store certain graph data indicating the graph that is converted from the relational data in the first memory unit or in the second memory unit, based on at least any of specification information which specifies a storage destination for the certain graph data, relations of connection with respect to the graph data stored either in the first memory unit or in the second memory unit, and a data size of the relational data; and
a memory controller configured to, depending on a determination result of the determining unit, store the certain graph data either in the first memory unit or in the second memory unit.

2. The device according to claim 1, wherein, when the determining unit performs determination based on the relations of connection with respect to the graph data stored in the first memory unit or in the second memory unit,
if the certain graph data has the relations of connection, the determining unit determines to store the certain graph data in the second memory unit, and
if the certain graph data does not have the relations of connection, the determining unit determines to store the certain graph data in the first memory unit.

3. The device according to claim 1, wherein
the first memory unit is a nonvolatile memory unit, and
the second memory unit is a volatile memory unit.

4. The device according to claim 1, further comprising an aligning unit configured to align graph data according to connection information of the nodes and the edges, wherein
the memory controller stores graph data in the first memory unit according to an alignment sequence of graph data that is aligned by the aligning unit.

5. The device according to claim 4, wherein the aligning unit aligns graph data based on a search sequence with respect to a source node.

6. The device according to claim 1, further comprising:
a sending unit configured to send a request message, which is issued in order to request for graph data, to an information providing device via a network; and
a receiving unit configured to receive response information, which contains the relational data corresponding to the request message, from the information providing device, wherein
depending on the response information, the determining unit determines whether to store the certain graph data of the graph that is converted from the received relational data in the first memory unit or in the second memory unit.

7. The device according to claim 6, wherein the request message can contain information indicating a source node of a graph, information indicating number of hops from the source node, information indicating a search method, classification information distinguished according to types of the nodes and the edges indicated by graph data, attribute information used in identifying attributes of the nodes and the edges, and response order information that indicates a response order based on at least either the classification information regarding the nodes and the edges or the attribute information regarding the nodes and the edges.

8. The device according to claim 6, further comprising an extracting unit configured to, when the receiving unit receives the response information containing graph data of a sub-graph that matches with the request message, refer to auxiliary information, which is included in the response information and which is used as an aid in generating the graph data of the sub-graph, and extract the graph data of the sub-graph that matches with the request message from the response information.

9. The device according to claim 1, wherein, in the case of storing new graph data in the first memory unit, the memory controller appends, to the new graph data, differentiation information that can be differentiated from the graph data that is already stored in the first memory unit or in the second memory unit.

10. The device according to claim 1, further comprising a detector configured to, with respect to an instance of the graph data stored in the first memory unit or the second memory unit, detect duplication of instances of the certain graph data that is converted from the relational data, wherein
if a detection result of the detector indicates no duplication, the determining unit determines to store the certain graph data in the first memory unit, and
if a detection result of the detector indicates duplication, the determining unit determines to store the certain graph data in the second memory unit.

11. The device according to claim 10, further comprising an index storing unit configured to store therein, as index information, a range in which the first memory unit or the second memory unit stores therein graph data, wherein
the detector detects duplication of instances of the certain graph data according to the index information.

12. An information providing device comprising:
a memory unit configured to store therein graph data which indicates at least either nodes or edges constituting a graph;
a receiving unit configured to receive a query regarding graph data from an information processing device via a network;
a second obtaining unit configured to obtain graph data corresponding to the query from the memory unit;
a response information generator configured to generate response information in which information indicating a display order to be adopted by the information processing device is added to the graph data that is obtained by the second obtaining unit; and
a sending unit configured to send the response information to the information processing device.

13. The device according to claim 12, wherein the response information generator generates the response information added with information indicating a source node of a graph, information indicating number of hops from the source node, information indicating a search method, classification information distinguished according to types of the nodes and the edges indicated by graph data, attribute information used in identifying attributes of the nodes and the edges, and information that indicates a display order based on at least either the classification information regarding the nodes and the edges or the attribute information regarding the nodes and the edges.

14. The device according to claim 13, wherein, when the receiving unit receives the response information containing graph data of a sub-graph that matches with the request message, the response information generator generates the response information that contains auxiliary information which is included in the response information and which is used as an aid in generating the graph data of the sub-graph.

15. An information system in which relational data containing relationships that can be converted into at least one graph is provided from an information providing device to an information processing device via a network, wherein
the information processing device includes
a first memory unit configured to be capable of store therein graph data which indicates at least either nodes or edges constituting a graph;
a second memory unit configured to be capable of storing therein graph data at an access speed faster than an access speed of the first memory unit;
a first obtaining unit configured to obtain the relational data;
a determining unit configured to determine whether to store certain graph data indicating the graph that is converted from the relational data in the first memory unit or in the second memory unit, based on at least any of specification information which specifies a storage destination for the certain graph data, relations of connection with respect to the graph data stored either in the first memory unit or in the second memory unit, and a data size of the relational data; and
a memory controller configured to, depending on a determination result of the determining unit, store the certain graph data either in the first memory unit or in the second memory unit.

16. A computer program product comprising a computer readable medium including an information processing program that stores graph data indicating at least either nodes or edges constituting a graph in either a first memory unit capable of storing therein graph data or a second memory unit capable of storing therein graph data at an access speed faster than an access speed of the first memory unit, wherein the program, when executed by a computer, causes the computer to execute:
obtaining relational data which contains relationships that can be converted into at least one graph;
determining, by a determining unit, whether to store certain graph data indicating the graph that is converted from the relational data in the first memory unit or in the second memory unit, based on at least any of specification information which specifies a storage destination for the certain graph data, relations of connection with respect to the graph data stored either in the first memory unit or in the second memory unit, and a data size of the relational data; and
storing the certain graph data either in the first memory unit or in the second memory unit depending on a determination result of the determining unit.
